(19) United States
(12) Patent Application Publication
(10) Pub. No.: US 2025/0333335 A1
(43) Pub. Date: Oct. 30, 2025

(54) Electrode and System for Electrochemical Oxidation of Aromatic Pollutants

(71) Applicant: City University of Hong Kong, Kowloon (HK)

(72) Inventors: Asma Batool, Layyah (PK); Jason Chun Ho Lam, Shatin (HK)

(21) Appl. No.: 19/089,599

(22) Filed: Mar. 25, 2025

Related U.S. Application Data
(60) Provisional application No. 63/638,560, filed on Apr. 25, 2024.

(51) Int. Cl. C02F 1/461; C02F 1/467; C02F 101/34; C02F 101/36; C23C 18/12

(52) U.S. Cl. CPC C02F 1/46109; C02F 1/4672; C23C 18/1216; C23C 18/1245; C23C 18/1291; C02F 2001/46142; C02F 2101/34; C02F 2101/36

(57) ABSTRACT

An electrode for electrochemical oxidation of aromatic pollutants is disclosed as including nano manganese oxide supported on conductive carbon cloth. A method of forming an electrode for electrochemical oxidation of aromatic pollutants includes (i) mixing a manganese precursor with a reducing sulphate to form a mixture; (ii) applying the mixture onto a conductive carbon layer; and (iii) calcinating the conductive carbon layer applied with the mixture to form nano manganese oxide on the conductive carbon layer.

### TECHNICAL FIELD OF THE INVENTION

The invention relates, generally, to the field of mineralization/degradation of aromatic pollutants by way of electrochemical oxidation, and more particularly, to an electrode and system for electrochemical oxidation/mineralization/degradation of aromatic pollutants.

### BACKGROUND OF THE INVENTION

The increasing concentrations of xenobiotic aromatic compounds in the environment pose considerable risks to human and ecosystem health. As such, a universal and environmentally benign electrocatalytic methodology for mineralizing/degrading organic pollutants would be a useful platform for removing pollutants from wastewater prior to discharge into the environment. However, the electrochemical degradation of parts-per-million (ppm) concentrations of pollutants is challenging.

Industrial and anthropogenic activities generate large amounts of harmful organic wastes that pose a serious threat to the environment and to human health. In particular, halogenated organic pollutants (HOPs) have high bioaccumulation potentials and are highly resistant to conventional biodegradation. Thus, HOPs persist in the environment, where they can bioaccumulate and cause acute cytotoxicity in humans and other organisms. For instance, triclosan (TCS) is a HOP that is widely used as an antiseptic and antimicrobial chemical in many quotidian goods, such as cosmetic, hygiene, and household cleaning products, and it has been entering wastewater treatment plants (WWTPs) in a range of concentrations (0.07 to 14,000 parts per billion) for more than 30 years. It was estimated that primary treatment can remove approximately 28% of TCS from wastewater, while secondary and tertiary treatments can remove over 80%. The TCS concentrations in WWTP influents and effluents worldwide are 0.0013-86.2 parts per million (ppm) and 0.0031-5.53 ppm, respectively, indicating that the complete removal of TCS from wastewater remains challenging.

Over the past decade, tertiary treatments, such as electrocatalytic treatments, have drawn increasing attention due to their unique ability to function immediately and robustly in ambient aqueous conditions. Moreover, use of electrochemical or hybrid methods for TCS degradation has been proposed, as shown in FIG. 1, and the rates of removal of ppm concentrations of TCS by such methods have ranged from 5.77 to 28.8 nmol min⁻¹. However, although all these methods operate under ambient conditions, many require elaborate electrodes such as boron-doped diamond (BDD), or even toxic elements such as lead, to degrade TCS. Some hybrid methods do not need elaborated or toxic materials; for example, an electrocatalytic Fenton method was shown to have a high TCS-removal rate (43.25 nmol min⁻¹). However, it generated stoichiometric quantities of ferrous ions to facilitate rapid degradation of TCS with hydrogen peroxide. Other advanced oxidation processes, such as photocatalytic processes and bio-chemical hybrid processes have been applied for TCS degradation and exhibited reasonable TCS-removal rates (28.8 nmol min⁻¹). Nevertheless, these methods have several limitations or require specific conditions such as costly electrodes, an organic co-solvent, or stoichiometric oxidants, thereby hindering their large-scale implementation. Therefore, there is a need to use Earth-abundant elements to fabricate active electrodes that can serve as an economic and feasible means of removing persistent TCS from wastewater.

Mineralization of some types of aromatic compounds has been achieved by electrooxidation on “non-active” anodes, including boron-doped diamond (BDD), PbO₂, SnO₂—Sb, and Ti/RuO₂ under room temperature and atmospheric pressure at fast rates (half-lives: tens to hundreds of minutes) and relatively low energy consumption, presumably by hydroxyl free radicals generated on the electrodes by electrolysis. The anode material is an important factor of anodic oxidation, and the electrode materials reported to date for aromatic pollutant degradation have serious limitations. BDD electrode is extremely costly and difficult to produce in large size for scaled up applications. SnO₂-based hybrid electrodes, such as Ti/SnO₂—Sb, are inexpensive but suffer from relatively short service lives, and, in addition, Sb is considered toxic. Possible release of toxic Pb ions is the main drawback for PbO₂ electrode applications. Ti/RuO₂ is also expensive, and ruthenium is highly toxic and carcinogenic. In addition, as discussed above, it is known that inert electrodes work by generating hydroxyl free radicals, and it was generally believed that hydroxyl free radicals are not very effective at degrading perfluoroalkyl acids (PFAAs), particularly perfluorooctanesulfonic acid (PFOS).

The invention seeks to eliminate or at least to mitigate such problems by providing a new or otherwise improved electrocatalysts, electrodes (as well as methods of forming such electrodes), and systems for mineralization of aromatic pollutants, such as TCS.

### SUMMARY OF THE INVENTION

The present invention relates to electrochemical oxidation of wastewater pollutants. This invention provides a method for preparation of structurally different electrodes and system for electrochemical oxidation or degradation of organic pollutants such as aromatic species, for example, endocrine disruptors (EDCs), e.g., triclosan.

A first aspect of the invention provides an embodiment of methods for preparation of structurally different electrodes using facile strategies. The electrode comprises metal oxide and a conductive support to oxidize or mineralize the aromatic pollutants.

A second aspect of the invention provides a use of the methods given in first aspect for mineralization of pollutants using electrochemical oxidation system.

A third aspect of the invention provides a colloidal suspension of aromatic pollutants in aqueous solution and then mineralization of such pollutants according to the second aspect.

A fourth aspect of the invention provides a use of the method according to first, second and third aspect for formation of mineralizable intermediates.

A fifth aspect of the invention provides a use of method according to first, second, third and fourth aspect for further mineralization of pollutants into mineral or inorganic components.

According to a further aspect of the invention, there is provided an electrode for electrochemical oxidation of aromatic pollutants, said electrode comprising nano manganese oxide on a conductive carbon layer.

According to a still further aspect of the invention, there is provided a method of forming an electrode for electrochemical oxidation of aromatic pollutants, including steps (i) mixing a manganese precursor with a reducing sulphate to form a mixture; (ii) applying said mixture onto a conductive carbon layer; and (iii) calcinating said conductive carbon layer applied with said mixture to form nano manganese oxide on said conductive carbon layer.

According to a yet further aspect of the invention, there is provided a system for electrochemical oxidation of aromatic pollutants, including at least an electrode for electrochemical oxidation of aromatic pollutants, said electrode comprising nano manganese oxide on a conductive carbon layer.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Embodiments of the present invention will now be described, by way of example only, with reference to the accompanying drawings, in which:

FIG. 1 is a table showing various advanced oxidation methods (including a method according to the present invention) to mineralize/degrade triclosan in aqueous environments. Note: Electro.=Electrocatalytic; Photo.=Photocatalytic; E-Fenton=Electrocatalytic Fenton; Conc.=Triclosan concentration; N.D.=Not detected; BDD=Boron-doped diamond; MMO=Mixed metal oxides; SBC=Sludge-based carbon; CB=Carbon black; PC=Porous carbon; NPs=nanoparticles; EDTA=Ethylenediaminetetraacetic acid; DI Water=Deionized water; k=rate constant. *Unless specified otherwise, “ambient” refers to the conditions of 25° C. and 1 atm; *Volume data were not available;

FIG. 2a is a schematic illustration of the formation/fabrication of manganese dioxide (MnO₂) nanostructures on a conductive carbon cloth (CC) surface;

FIG. 2b is a scanning electron microscopy image of a piece of bare conductive carbon cloth (CC);

FIG. 2c is a scanning electron microscopy image of α-MnO₂ fabricated on a piece of conductive carbon cloth (CC) support (denoted as “α-MnO₂—CC”);

FIG. 2d is a scanning electron microscopy image of δ-MnO₂ fabricated on a piece of conductive carbon cloth (CC) support (denoted as “δ-MnO₂—CC”);

FIG. 2e show energy-dispersive X-ray spectroscopy elemental mapping images of δ-MnO₂ on carbon cloth (CC);

FIG. 3a shows X-ray diffraction patterns of uncoated carbon cloth, α-MnO₂—CC, and δ-MnO2-CC (where MnO2=manganese dioxide);

FIG. 3b shows Raman spectra of uncoated carbon cloth, α-MnO₂—CC, and δ-MnO₂—CC;

FIGS. 3c and 3d show, respectively, high-resolution X-ray photoelectron spectra of Mn 2p and O 1s and corresponding spectral decomposition of α-MnO₂—CC;

FIGS. 3e and 3f show, respectively, high-resolution X-ray photoelectron spectra of Mn 2p and O 1s and corresponding spectral decomposition of δ-MnO₂—CC;

FIG. 4a shows linear sweep cyclic voltammetry curves of α-MnO₂—CC in the non-Faradaic region of 0-0.8 V vs. (Ag/AgCl) at a scan rate of 20-200 mV s⁻¹ (where CC=carbon cloth, and MnO2=manganese dioxide), wherein its inset shows corresponding electrochemical double-layer capacitance (C_{dl}) plots obtained from cyclic voltammetry curves;

FIG. 4b shows corresponding linear sweep cyclic voltammetry curves of δ-MnO₂—CC obtained under the same conditions, wherein its inset shows corresponding electrochemical double-layer capacitance (C_{dl}) plots obtained from cyclic voltammetry curves;

FIG. 4c shows corresponding cyclic voltammetry curves of uncoated CC electrodes obtained under the same conditions, wherein its inset shows corresponding electrochemical double-layer capacitance (C_{dl}) plots obtained from cyclic voltammetry curves;

FIG. 5a shows efficiencies of degradation of triclosan (TCS) by α-MnO₂—CC and O—MnO₂—CC at different current densities (where MnO2=manganese dioxide, and CC=carbon cloth);

FIG. 5b shows electrocatalytic activity of MnO₂—CC electrodes for some common aromatic pollutants, namely, bisphenol A (BPA), triclosan (TCS), 4-chlorophenol (4-CP), 2,4,6-Trichlorophenol (2,4,6-TCP) and 2-bromophenol (2-BrPh);

FIG. 5c shows In(C/C₀) vs time of α-MnO₂—CC at a current density of 20 mA (where C ═C_{f}, and C₀═Cᵢ) indicating the first-order behavior of α-MnO₂—CC, the inset table showing the corresponding first-order parameters for TCS and related EDCs;

FIG. 5d shows In(C/C₀) vs time of δ-MnO₂—CC at a current density of 20 mA (where C ═C_{f}, and C₀═Cᵢ) indicating the first-order behavior of δ-MnO₂—CC, the inset table showing the corresponding first-order parameters for TCS and related EDCs;

FIG. 6a shows electron paramagnetic resonance analysis of electrochemical oxidative mineralization of triclosan (TCS) by α-MnO₂ electrocatalysts according to the present invention in the presence of Cl;

FIG. 6b shows electron paramagnetic resonance analysis of electrochemical oxidative mineralization of triclosan (TCS) by α-MnO₂ electrocatalysts according to the present invention in the absence of Cl;

FIG. 6c shows electron paramagnetic resonance analysis of electrochemical oxidative mineralization of triclosan (TCS) by α-MnO₂ electrocatalysts according to the present invention in the absence of spin trap;

FIG. 6d shows electron paramagnetic resonance analysis of electrochemical oxidative mineralization of triclosan (TCS) by δ-MnO₂ electrocatalysts according to the present invention in the presence of Cl;

FIG. 6e shows electron paramagnetic resonance analysis of electrochemical oxidative mineralization of triclosan (TCS) by δ-MnO₂ electrocatalysts according to the present invention in the absence of Cl;

FIG. 6f shows electron paramagnetic resonance analysis of electrochemical oxidative mineralization of triclosan (TCS) by δ-MnO₂ electrocatalysts according to the present invention in the absence of spin trap;

FIG. 6g shows formation of hypochlorous acid in the absence of TCS;

FIG. 6h shows formation of hypochlorous acid in the presence of TCS;

FIG. 6i shows total organic carbon removal by the electrochemical oxidative mineralization of TCS and structurally similar endocrine disruptors (EDCs) by the MnO₂ catalysts according to the present invention;

FIG. 7 shows possible pathway of electrochemical oxidative mineralization of TCS in an aqueous environment based on products that can be observed by mass spectrometry;

FIG. 8a shows comparison of electrocatalytic performances of common electrode and manganese dioxide (MnO₂)-based electrodes for degradation of several endocrine disruptors (EDCs),

FIG. 8b shows degradation of triclosan (TCS) by α-MnO₂—CC, by δ-MnO₂—CC in the absence of synthetic leachate (SL), and by δ-MnO₂—CC in the presence of SL, respectively, on a large scale (300 mL). *Sampled at 60 minutes;

FIG. 9a shows an SEM image of δ-MnO₂—CC at low magnification;

FIG. 9b shows a top view SEM image of δ-MnO₂—CC at high magnification;

FIG. 10a shows EDS mapping signal of MnO2 nanostructures of α-MnO₂—CC;

FIG. 10b shows EDS mapping signal of MnO2 nanostructures of δ-MnO₂—CC;

FIG. 11 shows XRD patterns of α-MnO₂ and δ-MnO₂ residual powder;

FIG. 12 is a table showing EDS mapping content of the different elements for both phases (alpha and delta) of MnO₂ anchored on the CC;

FIG. 13 shows adsorption study of a number of EDCs using α-MnO₂—CC and δ-MnO₂—CC at ambient conditions;

FIG. 14a shows structural representations of the pollutants that have been degraded effectively and efficiently by electrodes, electrocatalysts and systems according to the present invention;

FIG. 14b shows electrocatalytic oxidative activity of α-MnO₂—CC and δ-MnO₂—CC at 10 ppm of EDC at 20 mA (4.5 hrs) at room temperature on a number of EDCs;

FIG. 14c shows EDC degradation efficiencies at different current densities using α-MnO₂—CC;

FIG. 14d shows EDC degradation efficiencies at different current densities using δ-MnO₂—CC;

FIG. 14e shows impact of electrolysis time passing through the system while electrocatalysis at constant current density (20 mA) using α-MnO₂—CC;

FIG. 14f shows impact of electrolysis time passing through the system while electrocatalysis at constant current density (20 mA) using δ-MnO₂—CC;

FIG. 15a shows XRD patterns of α-MnO₂—CC after electrolysis of the EDCs in FIG. 15a;

FIG. 15b shows XRD patterns of δ-MnO₂—CC after electrolysis of the EDCs in FIG. 15b;

FIG. 16 is a table showing total organic carbon (TOC) content after electrolysis of both MnO2 electrodes without compound, in which “TC” means “total carbon” and “IC” means “inorganic carbon”;

FIG. 17 shows TCS degradation using δ-MnO₂—CC, in the presence and absence of chlorine environment; and

FIG. 18 shows schematically a system for electrochemical oxidation of aromatic pollutants according to an embodiment of the present invention.

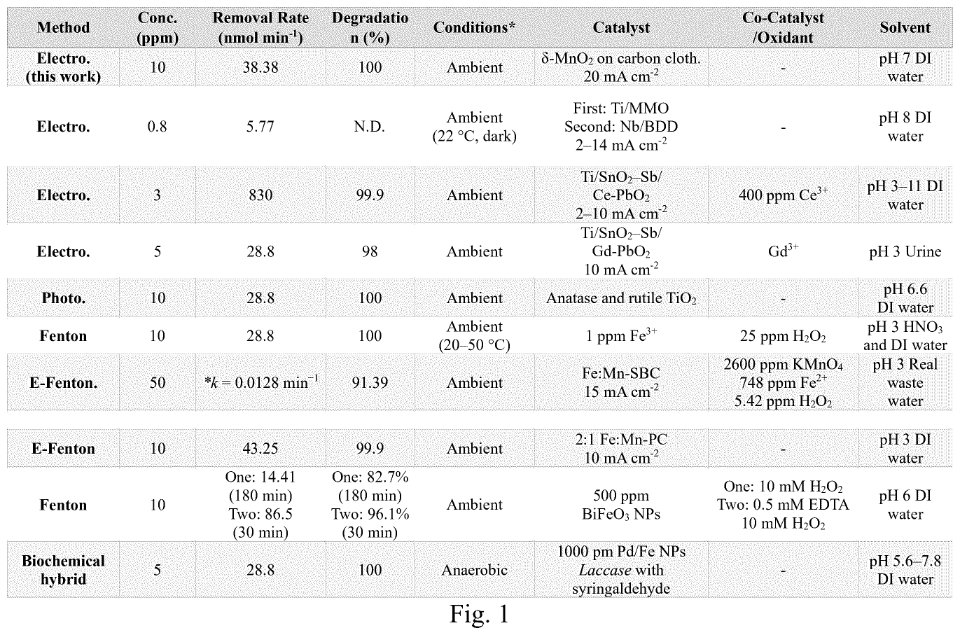

### DETAILED DESCRIPTION OF THE EMBODIMENTS

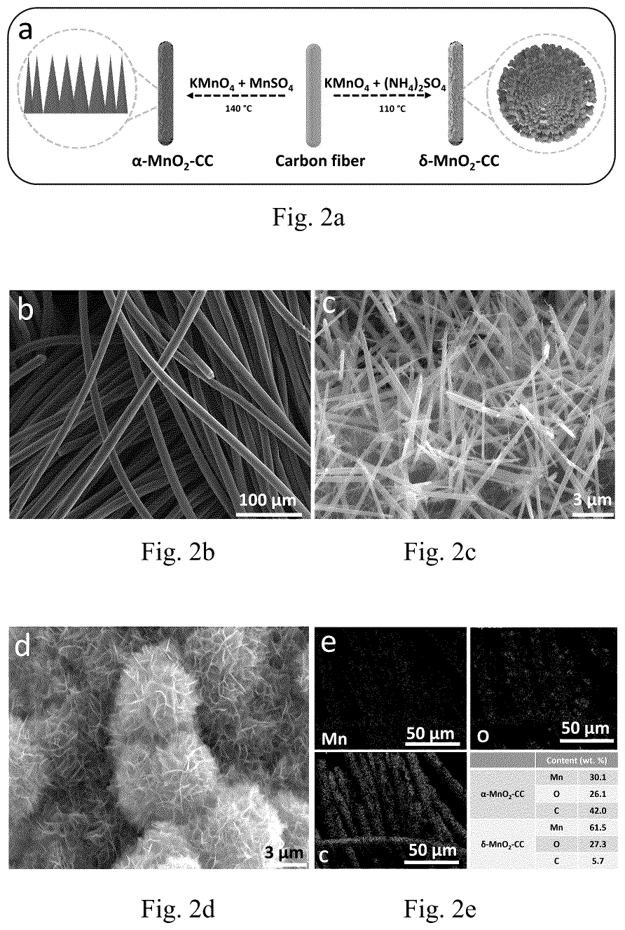

The present invention provides embodiments of an electrode, a method of forming such an electrode, and system for electrochemical oxidation/degradation/mineralization of aromatic pollutants in aqueous solution. In summary, an embodiment of method includes the contact between manganese oxide electrodes and aqueous solution of aromatic pollutants in a batch cell reactor which is connected with power source to provide stimulation. It also includes the preparation of porous and structurally different manganese oxide electrodes for the use of the present invention. Here manganese oxide electrodes are supported on a conductive carbon cloth. The purpose of using carbon cloth is to bind manganese oxide moieties with carbon network which subsequently enhances the electron flow between channels. As an embodiment, the methods of making the electrodes include: mixing of manganese precursor (e.g., potassium permanganate (KMnO₄)) with a reducing sulphate (such as MnSO₄ and (NH₄)₂SO₄) at room temperature to form a mixture; poured in autoclave containing hanged carbon cloth; maintaining 110° C. temperature in muffle furnace for 16 hours to produce porous manganese hydroxide deposited on carbon cloth; washing with distilled water at least three times; calcinating the carbon cloth containing manganese hydroxide to form manganese oxides; stored at room temperature. It also includes the construction of electrochemical oxidation system which consists of batch cell reactor, electrodes and power source. The electrochemical oxidation system uses manganese oxide electrode as a working electrode and nickel mesh as a counter electrode to oxidize or mineralize the aromatic pollutants to mineral components. As shown in FIG. 2a, KMnO₄ and MnSO₄ are applied on a carbon cloth to form α-MnO₂—CC on the carbon cloth; and KMnO₄ and (NH₄)SO₄ are applied on a carbon cloth to form δ-MnO₂—CC on the carbon cloth.

This invention comprises two main novel aspects. The first novel aspect of this invention is the preparation of binder free and structurally different manganese oxide electrodes for mineralization of various substituted or functionalized aromatic pollutants in ambient conditions (room temperature (25° C.) and pH˜7). This system presents many advantages over the previously reported electrochemical oxidation methods which involve potentially toxic, extremely expensive and/or inefficient materials for preparation of electrodes. On the contrary, manganese precursors are inexpensive, Earth-abundant materials. A second part of the first novel aspect is the easy and scalable production of manganese oxide electrodes which does not require any harsh conditions for preparation.

The second novel aspect of the present invention is the implementation of manganese oxide electrode for mineralization of various aromatic pollutants with different physicochemical properties. Moreover, the activity of manganese oxide electrodes has advantages over the other reported electrodes which require addition of toxic oxidizer to the system for generation of reactive species (ROS) for mineralization of pollutants. In contrast, manganese oxide-based electrodes disclosed here do not require any oxidizer to generate reactive species and it is efficient enough to generate ROS which participate in the formation of mineral components during the electrochemical reaction.

The present invention provides a novel hydrothermal exfoliation protocol to synthesize two different nano MnO₂ structures (α/δ-MnO₂) supported on carbon cloth, using inexpensive salts of manganese as the precursors. By this specific preparation, large-scale production of catalyst at a low cost is targeted to satisfy industrial requirements. Their electrocatalytic catalytic activities for ppm-level EDC degradation can be effected under ambient conditions at pH˜7 and 25° C. To establish structural activity relationship, α-phase MnO2 nanowires (NWs) and δ-phase nanosheet arrays (NSA) are grown on a carbon cloth surface and their degradation efficiency is evaluated on five different endocrine disruptors (EDCs). Moreover, the significance of this invention also addresses the large-scale implication under the same conditions.

As discussed, this invention relates to the use of manganese dioxide (MnO₂) (which is a chemically benign, Earth-abundant, and low-cost electrocatalyst) to mineralize triclosan (TCS) and other halogenated phenols at ppm-level. Two highly active versions of MnO₂ (denoted as α-MnO₂ and δ-MnO₂ respectively) were fabricated on a cost-effective carbon cloth (CC) support and denoted as α-MnO₂—CC and δ-MnO₂—CC, respectively, and their ability to oxidatively degrade TCS in a pH-neutral chlorinated environment that mimics wastewater effluent in ambient conditions was investigated. Total organic carbon (TOC) analysis confirmed that α-MnO₂—CC and δ-MnO₂—CC mineralized TCS under these conditions. Comprehensive characterization (crystal structure, morphology, surface area, and surface Mn oxidation states and oxygen species) of the various MnO2 nanostructures supported on the carbon cloth revealed that hierarchical 3D micro flower structure with better channelization of charge carriers, high resistance to charge recombination, and enhanced surface reactive sites, is favorable for the degradation of most of the halogenated phenols. Reactive oxygen species (ROS) were characterized by electron paramagnetic resonance spectroscopy and ultraviolet-visible spectroscopy. Furthermore, products and intermediates identified from time-resolved electrolysis were used to construct a detailed degradation pathway of TCS. Upon optimization, the TCS removal rate reached 38.38 nmol min⁻¹, which is greater than the rates reported from previous studies conducted in the presence of precious and toxic metal co-catalysts. The results of the present invention provide promising ecofriendly electrocatalysts which hold the upscaling potential for remediation of several organic pollutants.

Manganese oxide-based electrocatalysts (MnO₂) are highly promising electrocatalysts as they are inexpensive, chemically benign, and exhibit high catalytic activities. MnO₂ can exist in different structural phases, namely α-, β-, γ-, δ-, and A-phases, which consist of the same octahedral MnO6 units linked in different ways. Thus far, natural birnessite MnO₂ has been applied in slurries for non-electrocatalytic oxidation of organic compounds such as phenols, anilines, fluoroquinolones, and antibacterial amine-oxides. The high structure-activity variability in MnO₂ presents a great opportunity to develop a cost-effective electrocatalyst for removal of TCS from wastewater.

A novel hydrothermal exfoliation protocol to synthesize two different nano-MnO₂ structures, namely α-phase MnO2 nanoneedles (NNs) and δ-phase nanosheet arrays (NSAs) is provided, in which the nano-MnO₂ structures were anchored on a cost-effective CC support to form MnO₂ electrocatalysts. Both MnO₂ electrocatalysts mineralized ppm concentrations of TCS in a chlorinated wastewater mimic of saline WWTP effluent at room temperature under open-atmosphere conditions. Reactive oxygen species (ROS) were identified using electron pair resonance (EPR) and ultraviolet-visible (UV-vis) spectroscopy, and the mechanism of TCS degradation and the intermediates involved were elucidated using gas chromatography-mass spectrometry and substrate scope studies. Total organic carbon (TOC) analyses were performed to confirm TCS mineralization.

The present invention also discloses a type of electrochemical reactor which consists of simple components and uses minimal amount of energy to efficiently degrade or mineralize the targeted aromatic pollutants. For design and development of electrochemical reactors, defect-featuring electrocatalysts are only required which can be easily prepared at large scale through cost effective methods. The present invention also synthesized MnO₂ based electrodes via an economic and scalable protocol as a potential approach for producing amorphous electrocatalysts which retain high activity for several endocrine disruptors, providing an opportunity to turn lab-scale devices into fab-scale facilities via overcoming experimental and theoretical difficulties. The results demonstrate that it is promising to replace noble metal catalysts, such as Au or Ag, with Earth-abundant materials with remarkable catalytic performance approaching practical expectations, which opens an avenue for industrial wastewater remediation and achieves a significant progress in closing the anthropogenic carbon cycle for global sustainability. The other advantage of the present invention is the applicability of MnO2 electrodes.

### A. Experimental

### A. 1. Materials

All chemicals were used as received. Potassium permanganate (KMnO₄), ammonium sulfate ((NH₄)₂SO₄), manganese sulfate monohydrate (MnSO₄·H₂O), and 2-bromophenol (2-BrPh) were obtained from Macklin. 4-chlorophenol (4-CP), bisphenol A (BPA), and triclosan (TCS) were obtained from TCI. 2,4,6-Trichlorophenol (2,4,6-TCP) was obtained from Thermo Scientific. Methanol (HPLC grade), acetone, and ethanol (Analytical grade) were used. Sodium sulfate (Na₂SO₄) and sodium chloride (NaCl) were obtained from Fisher.

### A.2. Fabrication of MnO2 Nanostructures on a Carbon Cloth Support

MnO₂ nanostructures were fabricated on a piece of conductive carbon cloth via hydrothermal exfoliation. First, the carbon cloth was sonicated in acetone, ethanol, and DI water to remove adsorbed impurities. For α-phase MnO₂ preparation, the sonicated carbon cloth (1 cm×3 cm) was hung on the walls of a Teflon-lined autoclave while immersed in 40 mL of an aqueous solution of a mixture of 220 mg KMnO₄ and 60 mg MnSO₄·H₂O. Thus

$$\frac{Weight of {MnSO}_{4} \cdot {H}_{2} O}{Weight of {KMnO}_{2}}$$

of the aqueous solution of KMnO₂ and 60 mg MnSO₄·H₂O. Thus, MnSO₄·H₂O is about 3/11 Next, the autoclave was sealed, heated at 140° C. for 20 h, and cooled to room temperature overnight. As a result, a thin film of α-phase MnO₂ (α-MnO₂) was deposited on the carbon cloth, with some residual powder left at the autoclave bottom. δ-phase MnO₂ (δ-MnO₂) was prepared on a piece of conductive carbon cloth under similar hydrothermal conditions, but with different precursors and heat treatment. Here, the hanging sonicated carbon cloth was immersed into 40 mL of a solution containing a mixture of 126.4 mg KMnO₄ and 42.8 mg (NH₄)₂SO₄ and was heated at 110° C. for 20 h. Thus,

$$\frac{Weight of {( {NH}_{4} )}_{2} {SO}_{4}}{Weight of {KMnO}_{2}}$$

of the aqueous solution of KMnO₂ and (NH₄)₂SO₄ is about ⅓.

All MnO₂ electrodes were annealed at 350° C. for 2 h at a heating rate of 10° C. min⁻¹. The respective electrodes were denoted as α-MnO₂—CC and δ-MnO₂—CC. The electrodes were stored at room temperature until use. The residual dark brown (α-MnO₂) and black (δ-MnO₂) precipitates from the autoclaves were also collected and stored under similar conditions for further characterization.

### A.3. Electrocatalytic Oxidation Experiments and Product Analysis

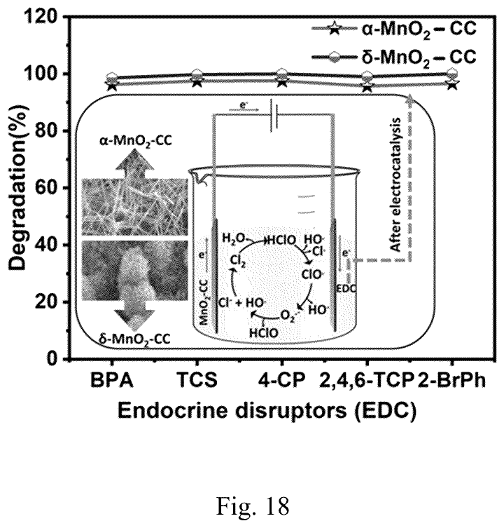

All electrolysis experiments were conducted in an undivided batch reactor (100 mL) containing an MnO₂ anodic working electrode (geometric area=1 cm²) and nickel foam as a cathodic counter electrode. A schematic illustration of such a system for electrochemical oxidation of aromatic pollutants is shown in FIG. 18.

All EDC solutions contained 10 ppm of EDCs and were prepared in aqueous media containing 50 mM Na₂SO₄ and 5 mM NaCl to provide background ionic strength and mimic the salinity of natural wastewater effluent. Chronopotentiometric electrolysis was performed at 20, 40, and 80 mA cm 2 at room temperature (23±2° C.). Aliquots of samples were collected periodically and analyzed using a high-performance liquid chromatography (HPLC) system (Agilent 1260 Infinity II) equipped with a photodiode array detector and a reverse-phase Zorbax XDB-C18 column (3.9×150 mm), which was eluted isocratically with a methanol: water (70:30, v/v %) mobile phase at a flow rate of 1 mL min⁻¹. The intermediate products were detected using a gas chromatograph (Shimadzu 2010 Ultra Gas Chromatograph-Mass Spectrometer) equipped with a capillary column (Agilent DB-5, 30 m×0.25 mm internal diameter×0.25 μm) in splitless mode at an injection temperature of 200° C. All samples subjected to gas chromatography analysis (100 mL each) were extracted with 4 mL of dichloromethane, followed by drying with anhydrous Na₂SO₄. Gas chromatograms were analyzed by comparison with the National Institute of Standards and Technology library and external references to identify intermediates. The extent of mineralization was determined by TOC analysis (Shimadzu, TOC-LCPH).

### A.4. Structural Phase and Morphology Analysis

The crystallinity and phase structure of the MnO₂ electrodes and residual powders were determined by X-ray diffraction (Rigaku Ultima IV diffractometer) using copper Kα radiation (40 kV, 30 mA). The qualitative and quantitative surface properties of prepared electrodes were evaluated by high-resolution scanning electron microscopy (FEI-Philips XL30 Esem-FEG). Raman spectroscopy was performed using a Raman spectrometer (EnSpectr R532, EnSpectr) equipped with a 20 mW, 532 nm laser. X-ray photoelectron spectroscopy (XPS) was performed on a Thermo Kα photoelectron spectrometer, and monoenergetic aluminum Kα radiation was employed to characterize and quantify the distribution of phases. All the electrochemical experiments, i.e., linear sweep voltammetry and cyclic voltammetry (CV), were conducted in a three-electrode setup using a CHI 660E electrochemical station (CH Instruments, Inc., Shanghai) in 15 mL of 1 M Na₂SO₄ electrolyte under ambient conditions. Unless specified otherwise, a standard bulk electrolysis reaction involves an as-prepared MnO₂ electrode was employed as the working electrode (area=1 cm²), and a platinum mesh and a 3.5 M silver/silver chloride (Ag/AgCl) electrode were used as the counter electrode and reference electrode, respectively.

### A.5. Measurement of the Electrochemical Active Surface Areas (ECSAs) of Uncoated and MnO₂-Coated Electrodes

The ECSAs of the electrodes were calculated from the electrochemical double-layer capacitance (C_{dl}) of the catalytic surface obtained from double-layer charging curves, which were determined by CV at 0-0.8V (a non-Faradaic region) at a scan rate of 20-200 mV s⁻¹ with an interval of 20 mV s⁻¹. Specifically, Cal was measured from the slope of the j-v curve, where j is the non-Faradaic capacitive current obtained from a CV curve, and v is the scan rate. Next, the ECSA was calculated using the following equation:

$$E C S A = {C}_{dl} / {C}_{s}$$

where Cₛ is the specific capacitance, which was set to 0.02 mF cm⁻² as previously published.

### B. Results

### B.1. Structural Analysis of α- and δ-MnO₂ Nanostructures

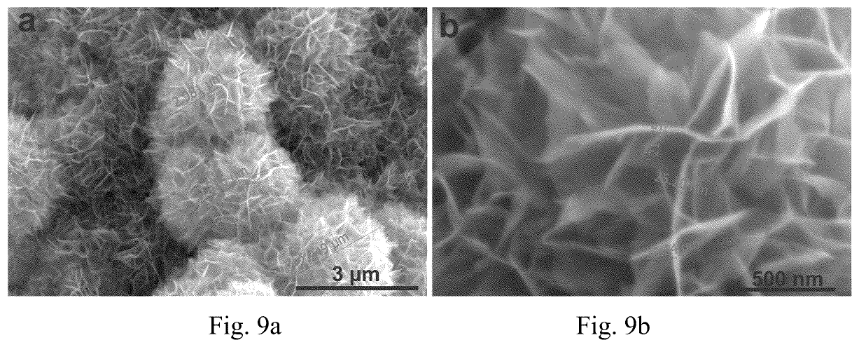

The nanostructures and morphologies of the MnO₂ electrodes were examined using scanning electron microscopy (SEM). The bare carbon cloth (CC) had a smooth fibrous morphology (as shown in FIG. 2b). Both the α-MnO₂ and δ-MnO₂ electrodes uniformly covered the carbon cloth surface. The α-MnO₂—CC exhibited interconnected nanoneedles (NNs) on the carbon cloth surface, with an estimated thickness of 200-300 nm (as shown in FIG. 2c). The δ-MnO₂—CC exhibited interconnected nanosheets array (NSAs) that formed a micron-sized sea-urchin-like morphology (as shown in FIG. 2d). These ordered NSAs formed an open-network-like structure (see FIG. 9a), and the average thickness of a single nanosheet was estimated to be 22.5 nm (see FIG. 9b).

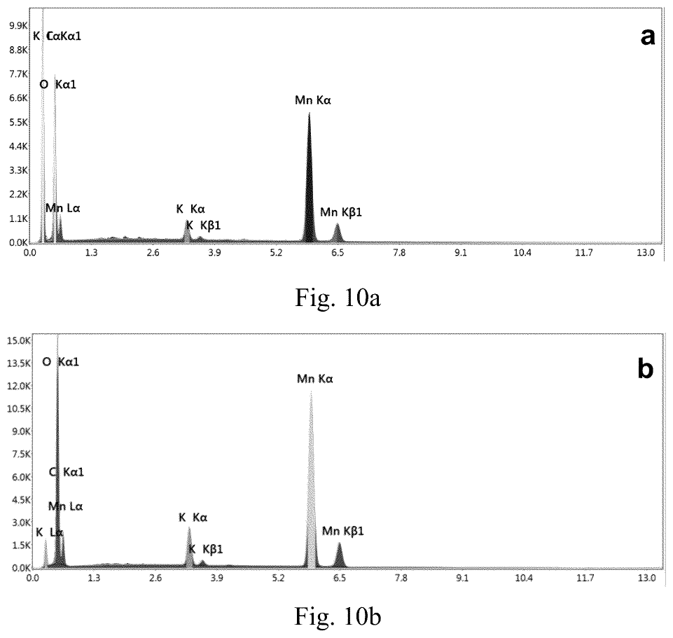

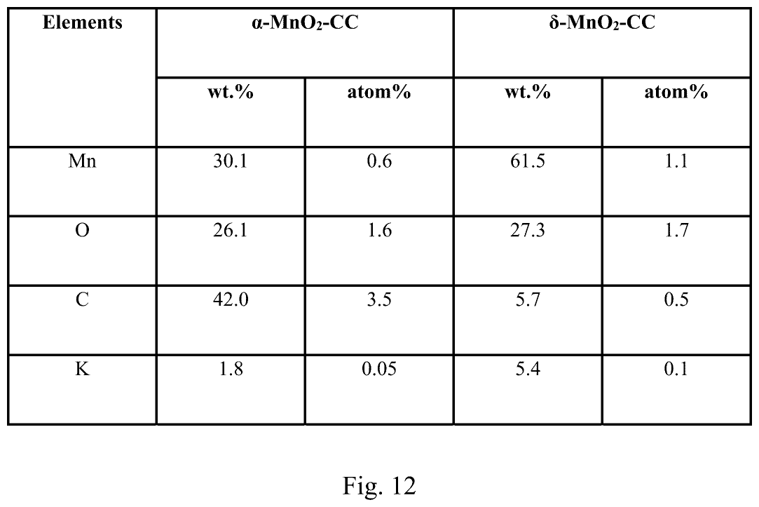

Energy-dispersive X-ray spectrometry (EDS) mapping analysis was performed to quantify elemental Mn, O, and C. The Mn content shown in FIG. 2e illustrates the relatively uniform Mn distribution on the surface of the MnO₂ electrodes. Strong Mn and O signals were observed (see FIGS. 10a and 10b) in both phases of MnO₂—CC, and the intensity was doubled on the δ-MnO₂—CC (61.54 wt %, FIG. 10b) compared with α-MnO₂—CC (30.06 wt %, FIG. 10a). In addition, the exposed carbon content of δ-MnO₂—CC (5.72 wt %) was much less than that of α-MnO₂—CC (42.02 wt %), indicating greater coverage of the CC surface on δ-MnO₂—CC than on α-MnO₂—CC (as per the table in FIG. 12).

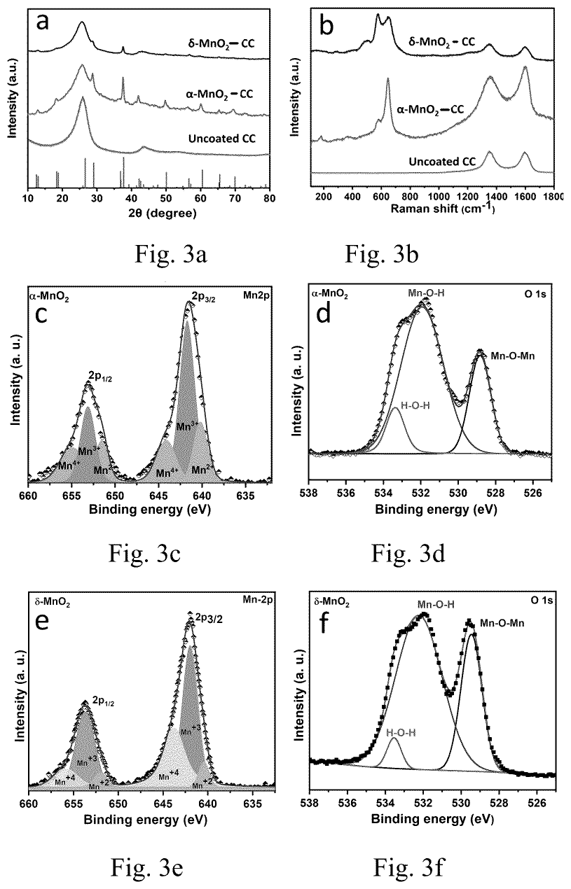

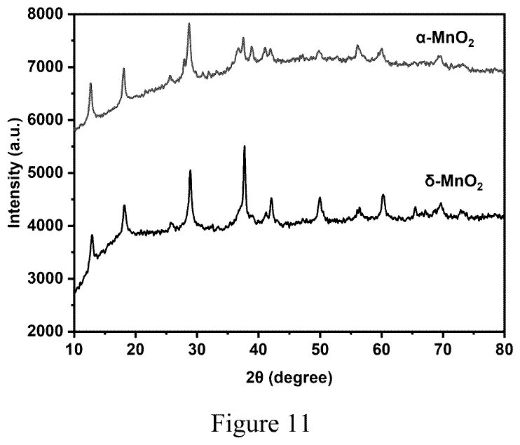

XRD was performed to examine the crystallinity of the MnO₂ electrodes. The XRD patterns of bare carbon cloth and of α-phase MnO₂ NNs and δ-phase MnO₂ NSAs on carbon cloth are shown in FIG. 3a. Two XRD peaks at 26° and 43° were observed on the bare carbon cloth surface, consistent with the literature. Neither α-MnO₂ nor δ-MnO₂ exhibited well-defined peaks, which indicated that they had amorphous structures. Nevertheless, the α-MnO₂ peaks and the δ-MnO₂ peaks are in good agreement with Powder Diffraction File card #44-0141 and Joint Committee on Powder Diffraction Standards card #18-802, respectively. The differences between the phase structures of the synthesized forms of MnO₂ were confirmed by their peak patterns. α-MnO₂—CC had a predominant (211) plane of Mn as shown by its narrow, high-intensity peaks. In contrast, δ-MnO₂—CC demonstrated broader and weaker (411) and (521) peaks at 38° and 50°, respectively. The XRD patterns of residual MnO₂ powders collected from the autoclave following the synthesis of α-MnO₂ and δ-MnO₂ were also analyzed to determine their crystal phases (as per FIG. 11). Their XRD patterns were consistent with those of MnO₂ deposited on the carbon cloth surface.

Raman spectroscopy results (as per FIG. 3b) confirmed that δ-MnO₂ had been formed, as the Raman spectrum contained representative peaks at 160.4, 504.6, 581.8, and 654.6 cm⁻¹, which are consistent with the literature. The X-ray photoelectron spectra of α-MnO₂—CC and δ-MnO₂—CC are compiled in FIG. 3c to FIG. 3f. Two peaks centered on 642.4 and 654 eV and representing the spin-orbit doublet states of Mn 2p_{3/2} and Mn 2p_{1/2}, respectively, were present in the high-resolution spectrum of Mn 2p. After spectral decomposition, Mn existed in three valences: +2, +3, and +4. Both α-MnO₂ and δ-MnO₂ showed strong Mn³⁺ peaks at 642 and 654 eV for Mn 2p_{3/2} and Mn 2p_{1/2}, respectively. FIG. 3d and FIG. 3f respectively shows the O 1s core-level spectra of α-MnO₂—CC and δ-MnO₂—CC. In addition to the dominant Mn—O—Mn moieties in MnO₂, represented by the peak at approximately 528.8 eV, there were large proportions of Mn—O—H moieties (i.e., Mn ions bonded with hydroxyl groups) and H—O—H moieties (i.e., absorbed water), represented by peaks at approximately 531.9 and 533.4 eV, respectively. The relative surface proportions of Mn³⁺ and Mn⁴⁺ (Mn^{3+/4+}) are often considered the main factors influencing the performance of Mn catalysts. For instance, a large proportion of Mn³⁺ on the surfaces of bifunctional catalysts has been found to facilitate the oxygen evolution reaction (OER). Conversely, a small proportion of Mn⁴⁺ on the surfaces of bifunctional catalysts has been suggested to enhance their adsorption of organic compounds. The Mn^{3+/4+} values for α-MnO₂—CC and δ-MnO₂—CC were 2.7079 and 1.6000, respectively, which match well with the catalytic findings.

### B.2. Determination of the ECSAs of the MnO₂ Electrodes

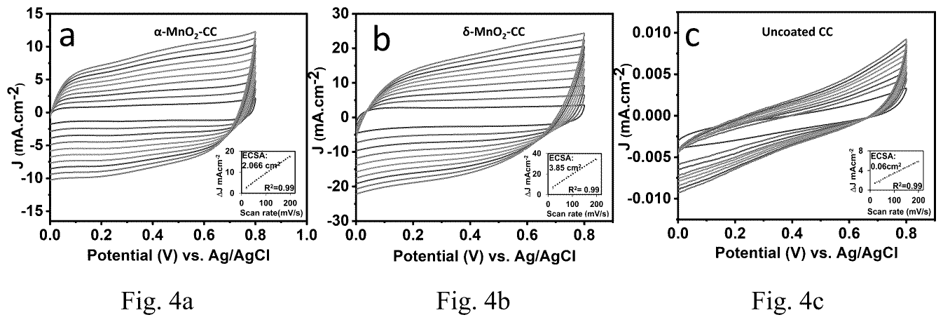

Electrochemical characterization of the MnO₂ electrodes was conducted in a three-electrode batch system. Their ECSAs were determined via CV at 0-0.8 V in the non-Faradaic current region at a range of scan rates, i.e., 20-200 mVs⁻¹, with data collected every 20 mV. FIGS. 4a to 4c show the cyclic voltammograms of MnO₂-modified and uncoated electrodes measured in 1 M Na₂SO₄ solution. Cal was determined by plotting the scan rate vs. the change in current density (ΔJ=J_{anodic}−J_{cathodic}), as the resulting linear slopes equal 2C_{dl}. The ECSAs of the α-MnO₂ electrode and δ-MnO₂ electrode were 33 and 62 times higher, respectively, than that of the CC electrode. Moreover, the surface area of the δ-MnO₂ electrode was twice that of the α-MnO₂ electrode, which accounts for the effectiveness of the δ-MnO₂ electrode in degrading small aromatics, as described in later sections (B.5).

### B.3. Electrocatalytic TCS-Degradation Performance of α- and δ-MnO₂ Electrodes

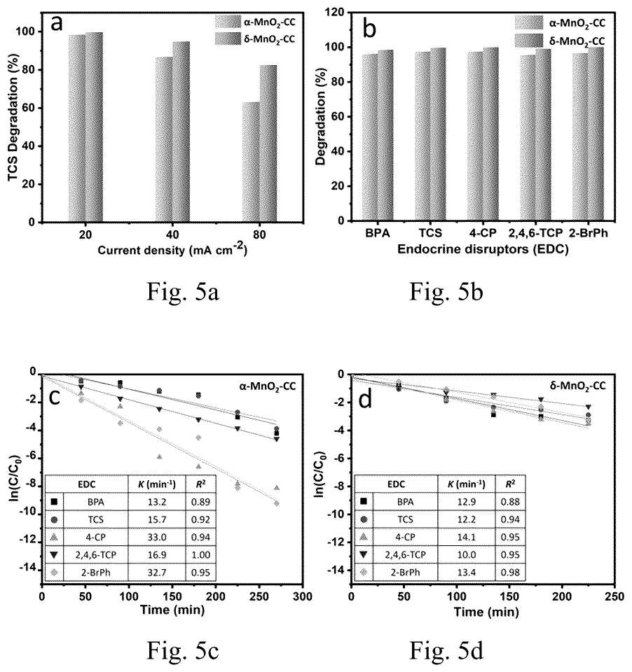

The electrocatalytic performance of the as-prepared α-MnO₂ and δ-MnO₂ in the oxidative degradation of TCS was evaluated via chrono-potentiometric electrolysis in an aqueous environment containing 5 mM NaCl and 50 mM Na₂SO₄ at room temperature and atmospheric pressure. NaCl was added to provide conductivity and to mimic the typical chloride-ion concentration of wastewater. As FIG. 5a shows, the oxidative degradation of TCS by α-MnO₂ and δ-MnO₂, respectively, decreased as the current increased, which indicated that the degradation efficiency was compromised by the increasing competitiveness of the OER driven by anodic water splitting. At 20 mA cm⁻², the proportion of TCS degraded by α-MnO₂ and δ-MnO₂ reached 97.27%+2.7% and 99.44%±1.4%, respectively, but at 40 mA cm⁻², this decreased to 85.18%±5.7% and 88.92%±5.5%, respectively. This result indicates that compared with δ-MnO₂, α-MnO₂ was more affected by the OER. At 80 mA cm⁻², the proportion of TCS degraded by α-MnO₂ was only 63.27%±7.3%, whereas that degraded by δ-MnO₂ remained reasonably high, i.e., 82.58%±3.1%.

The greater tendency of α-MnO₂ than δ-MnO₂ to exhibit the OER at high currents is consistent with a previous electrochemical observation that the α phase has a lower overpotential for OER than the δ phase; this implies that α-MnO₂ will trigger OER before δ-MnO₂. The OER activity of α-MnO₂ is superior to that of δ-MnO₂ because the former has a greater Mn^{3+/4+} ratio on its surface, as demonstrated by XPS (see FIG. 3c). Mn³⁺ favors the occurrence of the OER because the single electron occupying its σ*-orbital (e.g.) is transferred to its O—O Π*-orbital when Mn³⁺ is oxidized to Mn⁴⁺. The model supports the XPS-based analysis of the surface, which revealed that a Mn^{3+/4+} ratios for the α- and δ-phases were 2.7079 and 1.6000, respectively (see FIG. 3c and FIG. 3e). Thus, compared with the δ-MnO₂ catalyst, the α-MnO₂ catalyst had a larger proportion of Mn³⁺, which shifted its activity from TCS degradation toward the OER.

In addition to δ-MnO₂ having a wider electrochemical window for the OER than α-MnO₂, δ-MnO₂ absorbed more TCS. Specifically, in an open-circuit TCS adsorption control experiment, δ-MnO₂ absorbed 13.7% of the TCS to which it was exposed, whereas α-MnO₂ adsorbed only 8.3% of the TCS to which it was exposed. This is attributable to the ECSA of δ-MnO₂ being greater than that of α-MnO₂ (3.847 cm² vs 2.066 cm²) (see the insets of FIG. 4a and FIG. 4b).

During the bulk electrolysis of TCS, trace amounts of chlorinated mono-aromatic intermediates were detected. To elucidate the degradation pathways and obtain comprehensive mechanistic insights, TCS and the chlorinated mono-aromatics 4-CP and 2,4,6-TCP were subjected to time-resolved electrolysis on α-MnO₂ and δ-MnO₂ to investigate the relative rates of degradation by each catalyst. Two additional EDCs that are structurally similar to TCS were also examined under these conditions. The two additional EDCs are BPA, due to its di-aromatic structure, and 2-BrPh, due to its halogenated structure. All electrolysis were performed at 20 mA cm⁻² to minimize the possibility of competition with the OER. A pseudo-first-order kinetic analysis was conducted to calculate the degradation rate constants (k) (min⁻¹) (see FIG. 5c and FIG. 5d).

Under the initial conditions (j=20 mA cm⁻²), α-MnO₂ performed slightly better than δ-MnO₂, as all of the k values of the former were greater than those of the latter. All degradation patterns obeyed the pseudo-first-order kinetic model, as the data exhibited a good fit, i.e., the average coefficients of determination were 0.92 (0.07) and 0.94 (0.04) for the α-MnO₂ and δ-MnO₂ data set, respectively, in a linear regression using In(C/C₀)=−kt. The k of TCS degradation was 15.7 min⁻¹ on α-MnO₂ and 12.2 min⁻¹ on δ-MnO₂. α-MnO₂ also degraded BPA at a greater rate than did δ-MnO₂, indicating the universal applicability of α-MnO₂. Halogenated aromatic species that appeared during TCS degradation were also examined. 2,4,6-TCP was degraded by both α-MnO₂ (k=16.9 min⁻¹) and δ-MnO₂ (k=10.0 min⁻¹), with its degradation by the former being slightly more efficient than its degradation by the latter. However, the rate constant for degradation of 4-CP by α-MnO₂ (k=33.0 min⁻¹) was twice that for degradation of 4-CP by δ-MnO₂ (k=14.1 min⁻¹). A control comparison using 2-BrPh was performed and a similar rate enhancement for α-MnO₂ over δ-MnO₂ (k=32.7 min⁻¹ vs 13.4 min⁻¹) was observed, which indicated that the rapid degradation observed on α-MnO₂ was not due to the chlorine substituent of 4-CP but rather its monomeric ring structure and mono-halogenation. Control experiments (see FIG. 5c and FIG. 5d) on open-circuit adsorption showed that α-MnO₂ and δ-MnO₂ had similar adsorption capacities for 4-CP and 2,4,6-TCP, which indicated that the superior catalytic activity of α-MnO₂ was attributable to its intrinsic properties, i.e., the fact that it had a greater Mn^{3+/4+} ratio (2.7079) than δ-MnO₂ (1.6000).

Overall, the degradation trend for α-MnO₂ was approximately 4-CP, 2-BrPh>2,4,6-TCP, TCS>BPA. The exceedingly high degradation of 2-BrPh and 4-CP by α-MnO₂ indicates that it excels at degrading halogenated mono-aromatics and does not appear to be restricted by the location of the halogen. An open-circuit adsorption control experiment was also performed using 4-CP and 2-BrPh and both α-MnO₂ and δ-MnO₂ catalysts. The results showed that δ-MnO₂ was slightly more effective than α-MnO₂ in adsorbing organic compounds, which excluded the possibility that favorable adsorption accounted for the high reactivity of α-MnO₂. Thus, the better performance of α-MnO₂ may be attributed to the fact that it has a greater Mn^{3+/4+} ratio than δ-MnO₂, which enhances the oxidative catalytic performance of α-MnO₂. The degradation trend for δ-MnO₂ was approximately 4-CP, 2-BrPh>BPA, TCS>2,4,6-TCP. This suggests that the accessibility of C—H sites on the aromatic ring of an EDC plays a key role in its oxidative degradation by δ-MnO₂. Specifically, 4-CP and 2BrPh have four accessible aryl C—H sites at which oxidation can occur; BPA and TCS also have four such sites per ring, but these sites may be sterically hindered by the bulky biphenyl structure of the molecules; and 2,4,6-TCP only has two accessible aryl C—H sites.

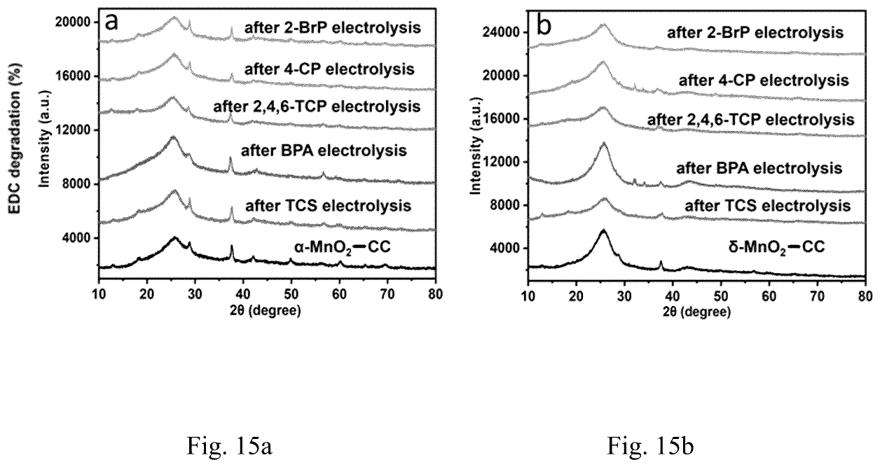

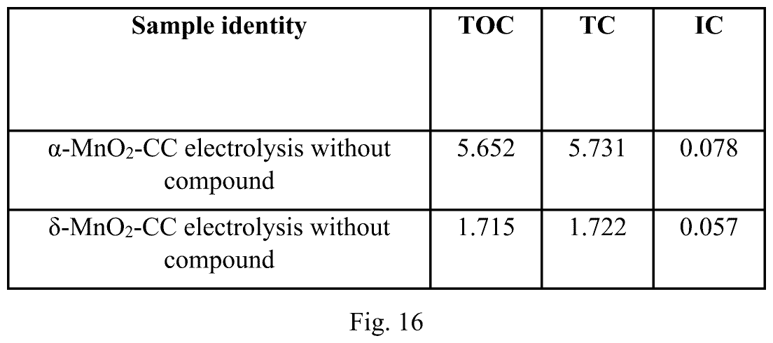

XRD analysis was conducted on all the MnO₂ catalysts after electrolysis, and the results showed that they exhibited good retention of their respective phases (see FIG. 15a and FIG. 15b). Thus, the α-MnO₂ peaks at 28.74° and 37.58° and the key δ-MnO₂ peaks at 38.3° retained good shapes after exposure to all the EDC substrates.

### B.4. Identification of ROS

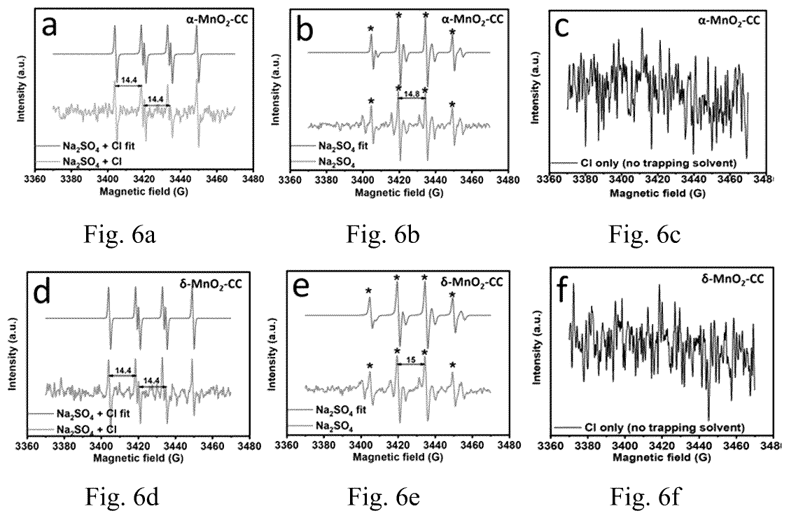

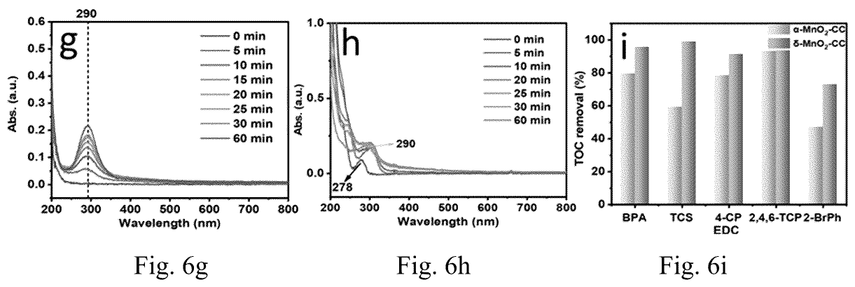

EPR and UV-vis spectroscopy was used to identify the ROS. The following text describes a possible mechanism based on the spectroscopic results. First, the anodic oxidation of two chloride ions (Cl⁻) affords molecular chlorine (see Eq. 1 below), which then combines with H₂O to yield hypochlorous acid (HClO) (see Eq. 2). The presence of HClO was confirmed by UV-vis spectroscopy as it showed an increase in the size of the peak at ˜290 nm, which matches the reported wavelength of HClO in UV-vis spectra (see FIGS. 6g and 6h). Next, HClO reacts with either a chlorine radical (Cl^{•}) (see Eq. 3) or a hydroxyl radical (HO^{•}) (see Eq. 4) to yield chlorine monoxide (ClO^{•}), which subsequently reacts with a hydroxide ion to afford a superoxide anion (O₂^{•-}) (see Eq. 5). As studies have suggested that ClO^{•} can react with HO^{•} to yield a chlorite ion, the reaction using spin-trap-free EPR spectroscopy was examined, and the results showed that it did not follow such a pathway (FIG. 6c and FIG. 6f). Specifically, the EPR spectrum of the reaction electrolyte (which contained both Na₂SO₄ and NaCl) contained no signals for HO^{•} because this species had been scavenged by Cl⁻ and the increasing amount of HClO (see Eq. 4). The reaction was separately examined using Cl⁻-free EPR spectroscopy, which confirmed that HO^{•} could be formed by both MnO₂ electrodes (see FIG. 6b and FIG. 6e). The presence of O₂^{•-} was also confirmed by EPR spectroscopy, which showed that the splitting pattern corresponded to 5,5-dimethyl-1-pyrroline N-oxide-superoxide with a hyperfine coupling constant of 14.4, which is consistent with the published value of 14.53. (see FIG. 6a). Finally, the reaction of HClO with O₂^{•-} forms additional HO^{•} and Cl⁻, which are subsequently converted to various reactive chlorine species (RCS), such as ClO^{•} and Cl′ (see Eq. 6).

$$2 C {l}^{-} \to 2 C {l}_{2} + 2 {e}^{-} \qquad Eq . 1$$

$$C {l}_{2} + {H}_{2} O \to H C l O + H C l \qquad Eq . 2$$

$$H C l O + C l \cdot \to C l O \cdot + {H}^{+} + C {l}^{-} \qquad Eq . 3$$

$$HClO + HO \cdot \to C l O \cdot + {H}_{2} O \qquad Eq . 4$$

$$ClO \cdot + {OH}^{-} \to {O}_{2}^{\cdot -} + {H}^{+} + C {l}^{-} \qquad Eq . 5$$

$$H C l O + {O}_{2}^{\cdot -} \to HO• + C {l}^{-} \to R C S \qquad Eq . 6$$

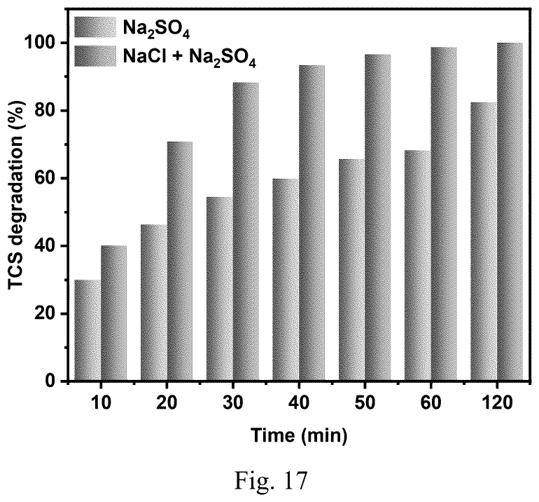

Based on the spectroscopic analysis, HClO appears to be the ROS responsible for the degradation of TCS. In the presence of TCS, a slight redshift of the λₘₐₓ from ˜290 to 304 nm indicated the consumption of HClO by TCS. After the complete mineralization/disappearance of TCS, the λₘₐₓ returned to ˜290 nm, indicating the reformation of HClO. In the absence of Cl⁻, however, HO^{•} was the dominant ROS (see FIG. 6b and FIG. 6e) as HClO could not form, and the degradation of TCS was significantly slower (see FIG. 17). This demonstrated that HO^{•} could not degrade TCS efficiently.

The TOC was measured to quantify the extent of organic content mineralization resulting from oxidative degradation (see FIG. 6i). The δ-MnO₂ degraded TCS and its structurally similar EDCs very efficiently. Over 90% of TOC was removed after electrochemical treatment of TCS, BPA, and halogenated phenols. In comparison, α-MnO₂ was less efficient in complete mineralization because as the TOC decreased, the electrochemical oxidative degradation of organics occurred via the OER rather than by mineralization. Meanwhile, although the catalytic performance of δ-MnO₂ was less active, it was less prone to exhibit the OER and thus achieved better mineralization. Only 2,4,6-TCP underwent more than 90% degradation on both α-MnO₂ and δ-MnO₂ catalysts, which indicates that such highly chlorinated species can be degraded effectively by these catalysts, regardless of the nature of their surfaces.

### B.5. Degradation Pathway of TCS

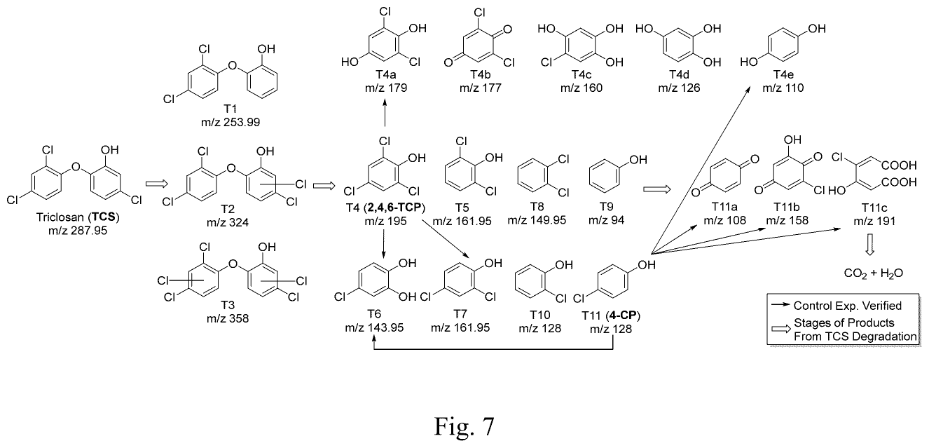

FIG. 7 depicts a possible TCS-degradation pathway that is based on literature findings and products detectable by mass spectrometry. The observed fragments were categorized based on their structural complexity and appearance during electrolysis.

Based on the detectable fragments, and without intending to be limited by the theory, it is proposed that TCS initially undergoes chlorination and dichlorination to form T1 (m/z 253.99), T2 (m/z 324), and T3 (m/z 358). Subsequently, cleavage of the aryl ether C—O bond produces various monoaromatic products: T4 (2,4,6-TCP, m/z 195), T5 (m/z 161.95), T6 (m/z 143.95), T7 (m/z 161.95), T8 (m/z 149.95), T9 (m/z 94), T10 (m/z 108), and T11 (4-CP, m/z 128).

A control experiment was conducted to electrolyze T4 (2,4,6-TCP) separately to determine whether multi-chlorinated aromatic monomers are degradable under our conditions. The reaction produced T4a (m/z 179), T6, and T7. As T6 and T7 were also formed during TCS electrolysis, this confirmed that T4 underwent degradation during the TCS degradation trials. Again, without intending to be limited by the theory, it is proposed that the electrode oxidizes T4-11 to yield T11a (m/z 108), T11b (m/z 158), and T11c (m/z 191). Although T11a-c were not observed directly during TCS electrolysis, it is posited that they are formed during TCS degradation because the oxidative treatment of monoaromatics is known to yield quinones and ring-opened carboxylic acids. A control experiment was therefore conducted in which T11 (4-CP) was electrolyzed under the same conditions and detectable amounts of T11a-c was obtained. The absence of T11a-c during TCS degradation is attributable to the fact that only low concentrations of T11 were formed. Without intending to be limited by the theory, it is hypothesized that T11a-c are further oxidized and mineralized to carbon dioxide and H₂O. The cleavage of dimers occurred at the ether C—O bonds, but this cleavage occurred non-selectively on either side. Chlorination also occurred, confirming that RCS were formed during electrolysis (see Eq. 6). Nevertheless, mineralization of aromatic compounds continued, as confirmed by the TOC analysis.

After the electrochemical treatment, the amount of organic carbon substantially decreased. There were also small amounts of a hydroxylated product (i.e., T6) observed during the TCS degradation and the control T4 trials, which confirmed that HO^{•} had been formed (see Eq. 6).

### B.6. Comparison of Performance and Determination of Large-Scale Applicability of MnO₂ Electrodes

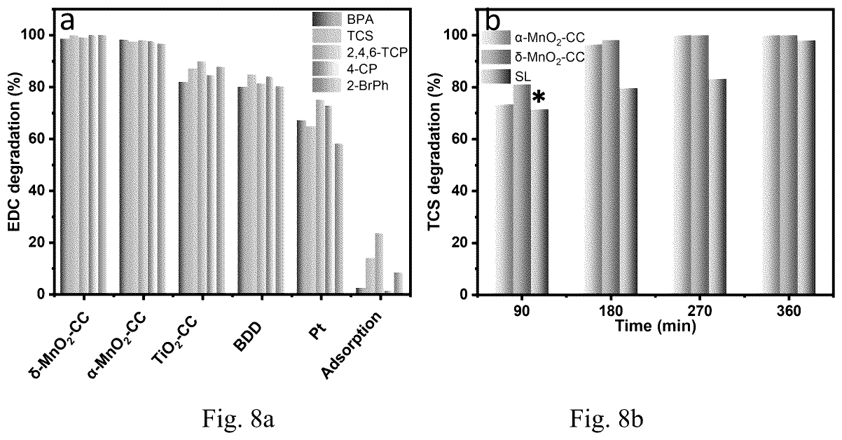

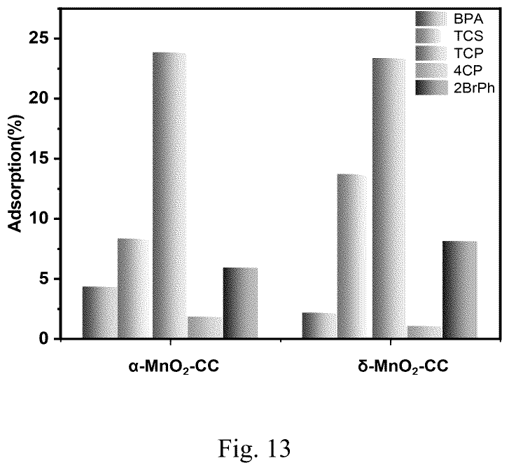

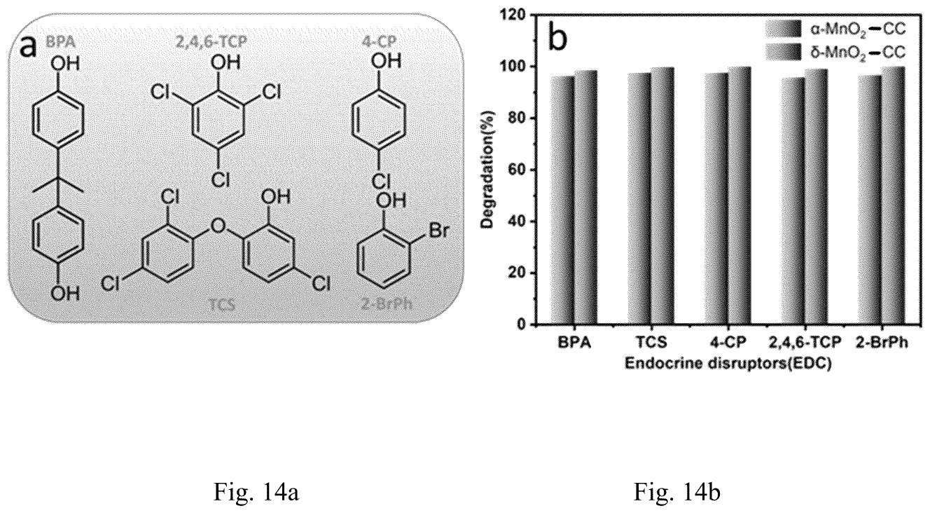

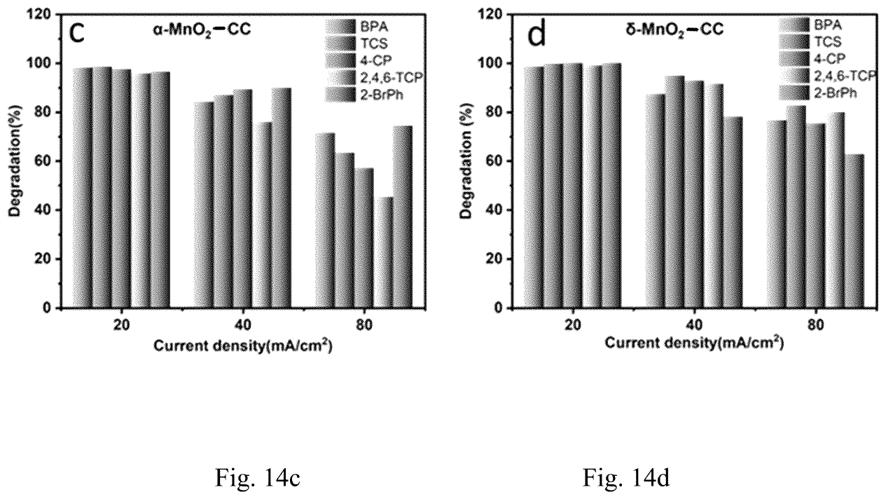

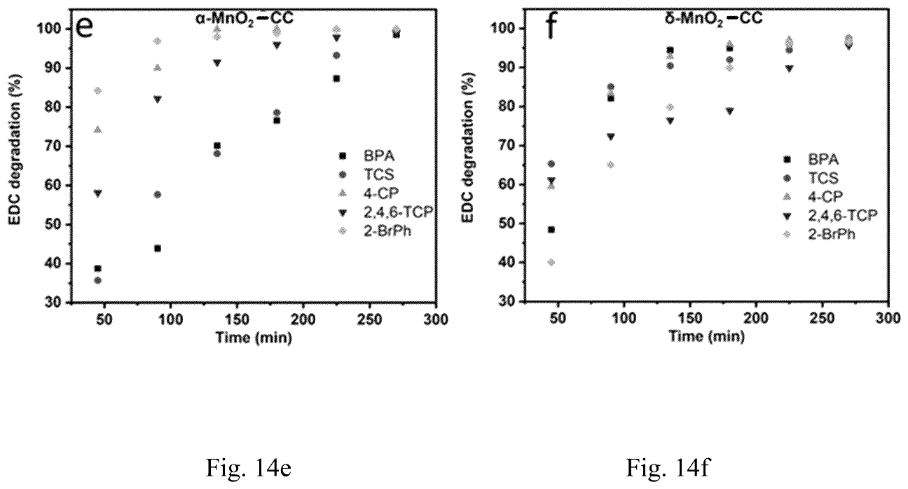

The performance of the α-MnO₂ and δ-MnO₂ electrodes was examined in a scaled-up (300 mL) electrolysis of TCS and various EDCs in the standard aqueous environment and a synthetic leachate (SL) environment. Their performances were compared with those of other common anodes, such as platinum mesh and BDD electrodes. Titania-CC was also prepared via a hydrothermal method, and its catalytic efficiency was compared with that of the other electrodes. α-phase MnO₂ and δ-phase MnO₂ exhibited the greatest catalytic degradation of all five EDCs (see FIG. 8a). An adsorption study in an open-circuit setting was also conducted using the MnO₂ electrodes, and the results confirmed that the removal of EDCs was achieved electrochemically (see FIG. 13). Thus, coupled with the results from the TOC analysis, it can be concluded that EDC degradation was achieved electrocatalytically rather than by surface physisorption. Compared with the standard aqueous environment, the degradation efficiency was slightly lower in the SL environment, but 98% TCS degradation was nevertheless achieved in 6 hours, which indicated that the presence of over 10 other wastewater species did not influence TCS degradation. These results confirm that noble metal catalysts, such as gold or Ag, can be replaced with Earth-abundant material-based catalysts, as the latter exhibit remarkable catalytic performances that approach practical requirements. This opens an avenue for future wastewater remediation and represents significant progress toward closing the anthropogenic carbon cycle to realize global sustainability.

### C. Conclusion

In summary, two highly active MnO₂ phases, α-MnO₂ and δ-MnO₂, were fabricated on a cost-effective conductive carbon cloth surface, and the resulting MnO₂ catalysts were comprehensively characterized. Both MnO₂ catalysts achieved nearly complete EDC degradation in a pH-neutral chlorinated aqueous environment that was similar to common wastewater. α-MnO₂—CC was found to possess unique nanostructures that facilitate the degradation of small aromatic compounds and to contain more Mn⁴⁺ than Mn³⁺ on its surface, endowing it with enhanced catalytic performance before it reached the onset potential of the OER. Compared with α-MnO₂, δ-MnO₂ delivered a more stable electrocatalytic performance overall and performed better at high current flows. These catalytic differences create the opportunity for targeted pollutant treatment, e.g., mono-aromatic vs. polyaromatic treatment. ROS identification by EPR and UV-vis spectroscopy confirmed the presence of various highly reactive intermediates, such as HClO, O₂^{•-}, and HO^{•}. TOC analysis confirmed that aromatic pollutants, e.g., TCS, were effectively mineralized by the catalysts. Finally, both α-MnO₂ and δ-MnO₂ exhibited good performance in a scaled-up setting (300 mL) and were able to degrade TCS efficiently in an SL environment. Thus, an efficient Earth-abundant metal catalyst that exhibits oxidative performance comparable with that of precious metal catalysts has been developed and disclosed.

1. An electrode for electrochemical oxidation of aromatic pollutants, said electrode comprising nano manganese oxide on a conductive carbon layer.

2. The electrode of claim 1, wherein said conductive carbon layer comprises at least a piece of conductive carbon cloth.

3. The electrode of claim 1, wherein said manganese oxide substantially uniformly covers said carbon layer.

4. The electrode of claim 1, wherein said manganese oxide is α-MnO₂, δ-MnO₂, or a combination thereof.

5. The electrode of claim 4, wherein said α-MnO₂ exhibits interconnected nanoneedles on said carbon layer.

6. The electrode of claim 4, wherein said δ-MnO₂ exhibits an interconnected nanosheets array which forms an open-network-like structure on said carbon layer.

7. A method of forming an electrode for electrochemical oxidation of aromatic pollutants, including steps:
(i) mixing a manganese precursor with a reducing sulphate to form a mixture;
(ii) applying said mixture onto a conductive carbon layer; and
(iii) calcinating said conductive carbon layer applied with said mixture to form nano manganese oxide on said conductive carbon layer.

8. The method of claim 7, wherein said manganese precursor includes potassium permanganate (KMnO₂).

9. The method of claim 7, wherein said reducing sulphate includes manganese sulphate monohydrate (MnSO₄·H₂O), ammonium sulphate ((NH₄)₂SO₄), or a combination thereof.

10. The method of claim 7, wherein said step (ii) includes immersing said conductive carbon layer into an aqueous solution of KMnO₂ and MnSO₄·H₂O.

11. The method of claim 10, wherein
$$\frac{Weight of {MnSO}_{4} \cdot {H}_{2} O}{Weight of {KMnO}_{2}}$$
of said aqueous solution of KMnO₂ and MnSO₄·H₂O is about 3/11.

12. The method of claim 7, wherein said step (ii) includes immersing said conductive carbon layer into an aqueous solution of KMnO₂ and (NH₄)₂SO₄.

13. The method of claim 12, wherein
$$\frac{Weight of {( {NH}_{4} )}_{2} {SO}_{4}}{Weight of {KMnO}_{2}}$$
of said aqueous solution of KMnO₂ and (NH₄)₂SO₄ is about ⅓.

14. The method of claim 7, further including a step (iv), after said step (iii), of annealing said conductive carbon layer with said nano manganese oxide at a preferred temperature for a preferred period of time at a heating rate of 10° C. min⁻¹.

15. The method of claim 7, wherein said conductive carbon layer comprises at least a piece of conductive carbon cloth.

16. A system for electrochemical oxidation of aromatic pollutants, including at least an electrode according to claim 1.

17. The system of claim 16 adapted for electrochemical oxidation of aromatic pollutants in ambient conditions.

18. The system of claim 16, wherein said aromatic pollutants include triclosan.
